(19) United States
(12) Patent Application Publication
(10) Pub. No.: US 2008/0283623 A1
(43) Pub. Date: Nov. 20, 2008

(54) WATER EVAPORATION SYSTEM USING NOZZLES ATTACHED TO A SUSPENDED CABLE

(75) Inventors: Darrin N. Haslem, Yorktown, VA (US); Michael T. Lawing, Yorktown, VA (US)

Correspondence Address: CLAUSEN MILLER, P.C, SUITE 1600, 10S. LASALLE STREET, CHICAGO, IL, 60603, US

(73) Assignee: EVAPORITE SYSTEMS, INC., Yorktown, VA (US)

(21) Appl. No.: 11/748,591

(22) Filed: May 15, 2007

(51) Int. Cl. B01D 1/20; B05B 1/14

(52) U.S. Cl. 239/1; 239/266

(57) ABSTRACT

A water evaporation system and method for disposing of excess water left over from oil or gas drilling, fracturing, and production operations and from other wastewater producing operations. The system comprises a pumping system for pumping the wastewater from a pond through a filtration system and then to one or more nozzle arrays attached to cables suspended over the pond.

### BACKGROUND

1. Field of the Invention

This patent relates to a system and method for evaporating fluids. More particularly, this patent relates to a system and method for evaporatingfluids such as wastewater produced from oil or gas drilling, fracturing, and production operations. The system and method involves spraying the wastewater through nozzles suspended from a cable located above the surface of a pond or reservoir.

2. Description of the Related Art

In oil and gas drilling operations drilling fluid is used to remove the drill cuttings from the bore hole and lubricate the drill. The drilling fluid is usually a mixture of clays, chemicals, weighting material and water. The drilling fluid is pumped down the hollow drill string to the bit where it picks up the drill cuttings, then circulated back up the annular space around the drill string to a drilling mud return line. From the return line the fluid passes across a shaker or screen which catches the larger cuttings while the rest of the drilling mud flows down into a mud pit. From the mud pit the drilling fluid may be sent to a particle separator where most of the remaining solids are separated from the wastewater which is then stored in a wastewater pond or reservoir.

The problem with this arrangement is that the collected wastewater eventually must be disposed of. Various evaporation systems have been devised to accomplish this task. Typically, these systems involve spraying the water into the air using high-pressure pumps to maximize the water droplet surface area in order to enhance evaporation.

Several water evaporation systems are known that either float on the pond or reservoir or are installed on the shore around the periphery of the pond or reservoir.

Horn et al. U.S. Pat. No. 4,449,849 describes a water evaporation system in which nozzles are placed around the periphery of a reservoir their spray is directed toward the center of the reservoir.

Foust U.S. Pat. No. 4,762,276 describes a water evaporation system that includes a floating tank that can float in the middle of a pond, a water collector tank suspended under the floating tank, and riser pipes attached to the collector tank at an angle to carry water from the collector tank to spray nozzles.

Co-owned pending U.S. patent application Ser. No. 11/277,985 describes a floating water evaporation system in which spray nozzles are mounted on risers extending upward from a water reservoir tank mounted between floating pontoons.

While each of these systems may be suitable for its intended purpose, there remains a need for a water evaporation system that achieves even better evaporation rates while minimizing saturation of the nearby ground.

Thus an object of the present invention is to provide an improved spray evaporation system that maximizes water evaporation rates while minimizing saturation of the nearby ground.

Another object of the invention is to provide a water evaporation system useful in oil and gas drilling operations that is easy to set up and tear down and is capable of operating in windy or sub-freezing temperatures.

Further and additional objects will appear from the description, accompanying drawings, and appended claims.

### SUMMARY OF THE INVENTION

The invention is a water evaporation system and method for use in disposing of excess water left over from oil or gas drilling, fracturing, and production operations and from other wastewater producing operations. The system comprises a pumping system for pumping the wastewater from the pond through a filtration system and then to one or more nozzle arrays attached by carabineers to cables suspended over the pond.

Each of the nozzle arrays comprises a section of rigid or semi-rigid conduitand a plurality of nozzles mounted to the conduit for converting the water into evaporable droplets. Preferably the nozzles are connected to quick connect fittings arranged along the conduit for easy set up and tear down. Flexible water hoses connect the pumping system to the suspended nozzle arrays and the nozzle arrays to each other.

The pumping system includes a suction pump for pumping the wastewater from the pond through the filtration system and into a holding tank. A discharge pump pumps the wastewater from the holding tank through flexible discharge hoses to the nozzle arrays suspended over the pond. The pumping system has an operable range of about 12 gallons per minute (GPM) to about 65 GPM, with a preferred rate of about 38 GPM, and can operate at pump pressures up to about 3,000 pounds per square inch gauge (PSI) with a preferred range of about 1,000 to about 1200 PSI.

The cables are functionally attached at one end to one or more vehicle mounted winches located on a truck or trailer parked near the pond and at their opposite, distal, ends to stakes set in the ground. The cables are positioned over tripod mounted spools positioned between the stakes and the pond to help elevate the cables above the pond surface. The winches are used to tighten the cables.

Preferably, the nozzles are arranged in staggered relationship along the length of the conduit, pointing upward at an angle of at least about 45 degrees with respect to the pond surface. Half of the nozzles are set at up to about a 90 degree angle with respect to the other half so that the resulting spray or fog is directed outwardly and upwardly along both sides of the conduit.

Any number of cables can be used, with the preferred number being two. More than one nozzle array can be suspended from each cable, with flexible hoses connecting the nozzle arrays. The nozzle arrays farthest away from the trailer may be connected by a pair of connector hoses having a drain manifold located between them to drain trapped water back into the pond.

The pumping and filtration systems may be located in the enclosed, portable truck or trailer. An intake hose runs from the pond to the suction pump, and one or more discharge hoses downstream of the holding tank run from a manifold inside the trailer to the nozzle arrays. Preferably, the trailer has outside connections for the intake hose and the discharge hoses.

### THE DRAWINGS

FIG. 1 is a perspective view of one embodiment of a water evaporation system according to the present invention.

FIG. 2 is a perspective view of a nozzle array used in the water evaporation system of FIG. 1.

FIG. 3 is a close up view of a portion of the nozzle array of FIG. 2.

FIG. 4 is a close up view of another portion of the nozzle array of FIG. 2 showing the connection between the nozzle array and a connector hose.

FIG. 5 is a perspective view of a winch used in the set up and operation of the water evaporation system of FIG. 1.

FIG. 6 is a perspective view of a tripod used in the water evaporation system of FIG. 1.

### DETAILED DESCRIPTION OF THE INVENTION

While this invention may be embodied in many forms, there is shown in the drawings and will herein be described in detail one or more embodiments with the understanding that this disclosure is to be considered an exemplification of the principles of the invention and is not intended to limit the invention to the illustrated embodiments.

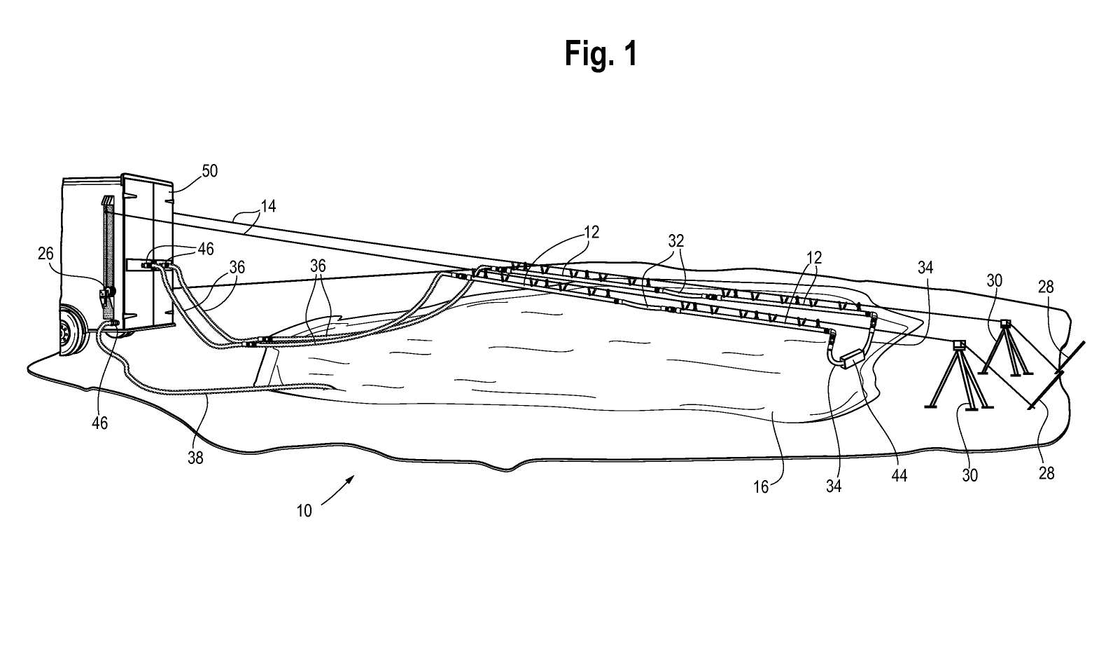

Turning to the drawings, there is shown in FIG. 1 one embodiment of the present invention, a water evaporation system 10 for use in disposing of excess water from wastewater producing operations such as oil and gas drilling. The excess water typically is held in ponds, reservoirs or storage tanks, and must be filtered before being sprayed through nozzles because of the solids suspended in thewaste water.

At its most basic, the system 10 comprises one or more nozzle arrays 12 attached to a cable 14 suspended over a wastewater pond 16, and a pumping system that pumps the water from the pond 16 through the nozzle arrays 12 where the water is atomized and evaporated. The system combines low volume and high pressure to achieve extremely small water droplet sizes and very high evaporation efficiencies.

The system 10 may be thought of as comprising five major components or subsystems: a suction pump, a filtration system, a high pressure discharge pump, the nozzle arrays 12 and the cable system. The entire system 10 can be housed and transported in a 7×14 foot enclosed trailer 50. Each major component and subsystem will now be described in detail.

Suction Pump

A suction pump (not shown in the drawings) is required to pump the wastewater from the pond or reservoir through the filtration system to a holding tank located inside the trailer 50. A commercially available medium head electric pump may be used for this task. A screen filter may be installed on the suction side of the pump to prevent large debris from damaging the suction pump and to keep floating hydrocarbon elements (oil, paraffin, etc.) from entering the pump through the screen.

Filtration System

The filtration system (not shown in the drawings) preferably comprises a dual module self-cleaning filter capable of removing suspended solids from the water before it enters the holding tank. Any suitable commercially available filter may be used, but preferably the filter is capable of filtering out 5 to 120 micron sized particles. As a result, cleaner water is put into the air and the nozzles will stay cleaner longer.

Water passing through the filtration system is sent to a 300 gallon water holding tank having an internal heater for cold weather. From the holding tank the water is pumped by a high pressure discharge pump to the nozzle arrays.

High Pressure Discharge Pump

The water evaporation system 10 uses a high pressure pump (not shown). The pumping system has an operable range of about 12 gallons per minute (GPM) to about 65 GPM, with a preferred rate of about 38 GPM, and can operate at pump pressures up to about 3,000 pounds per square inch gauge (PSI) with a preferred range of about 1,000 to about 1200 PSI. The lower flow rate (compared to previous evaporation systems) enables the filter to remove suspended solids out of the water prior to atomization, which in turn allows the use of more efficient nozzles. The lower pumping rate also allows conversion from a centrifugal pump to a positive displacement pump.

Coupled with the filtration system capable of eliminating suspended solids as small as 5 microns and the hydraulic atomization nozzles described below, the system 10 is capable of achieving atomization rates as low as 60 microns on average, compared with 300 microns in prior evaporation systems.

The high pressure discharge pump pumps the filtered water from the holding tank to the nozzle arrays 12 suspended over the pond 16. Any suitable high pressure pump can be used. Applicant has successfully used a commercially available CAT 3531 High Pressure Pump with a 15 HP, 480 3-phase engine.

Nozzle Arrays 12

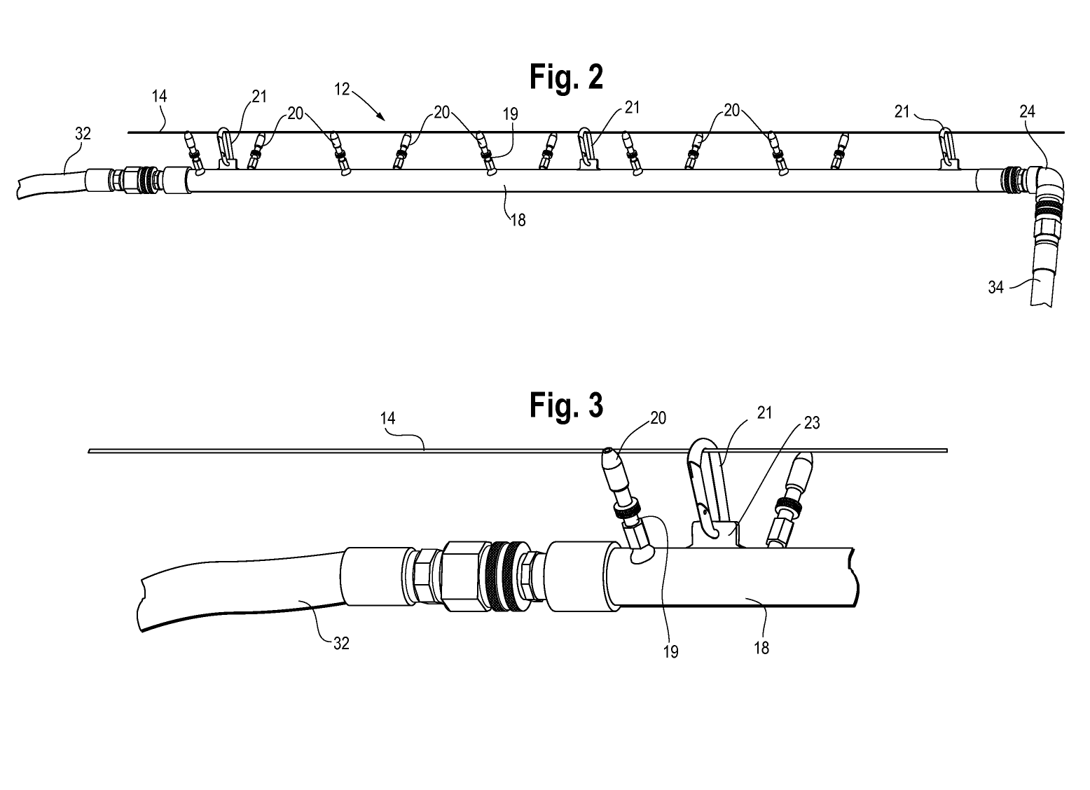

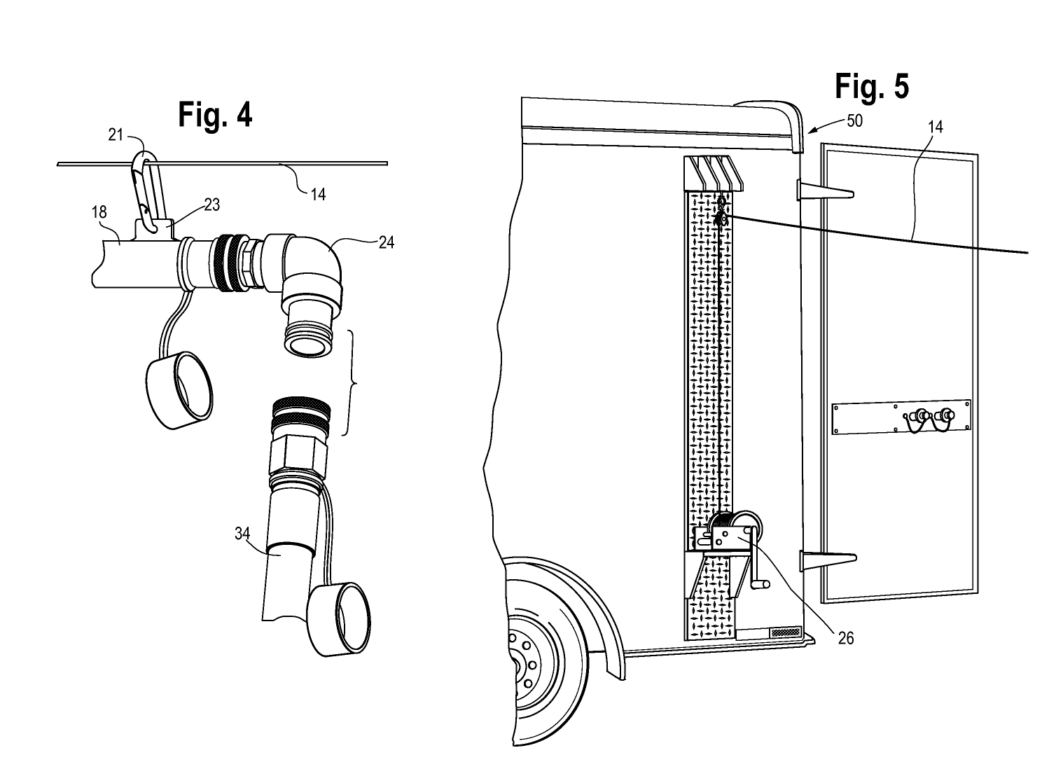

As best shown in FIGS. 2-4, each nozzle array 12 comprises a rigid or semi-rigid conduit 18, a plurality of spaced-apart, male, quick connect fittings 19 mounted to the conduit 18 along its length, and nozzles 20 connected to the quick connect fittings 19. The male quick connect fittings 19 may be arranged along the conduit 18 in any suitable manner. In the illustrated embodiment the quick connect fittings 19 (and this the nozzles 20) are arranged in staggered relationship along the length of the conduit 18, with half of the nozzles 20 pointing upward and outward on one side of the conduit and the other half pointing upward and outward on the other side of the conduit. Preferably the nozzles 20 describe an angle of at least about 45 degrees with respect to the pond surface, with the nozzles 20 on one side of the conduit set at up to about a 90 degree angle with respect to the nozzles 20 on the other side of the conduit 18.

Cable

A stainless steel cable 14 is suspended over the pond 16 and is secured at its proximate end by a trailer mounted winch 26 and at its distal end by a stake 28. A tripod 30 located on the far side of the pond 16 between the pond 16 and the stake 28 helps elevate the cable 14 above the pond surface.

The number of cables 14 and the number of nozzle arrays 12 hung from each cable 14 can vary depending on the application. In the system 10 illustrated in FIG. 1, two cables 14 are suspended over the pond 16 and two nozzle arrays 12 are hung from each cable 14. The nozzle arrays 12 on each cable 14 are connected to each other in series by a short jump hose 32. The nozzle arrays 12 are suspended from the cables 14 by carabineers 21 attached to tabs 23 welded to the conduit 18, although any suitable suspension means may be used.

The two nozzle arrays 12 farthest away from the trailer 50 are connected by a pair of connector hoses 34. A drain manifold 44 is located between the connect hoses 34. The drain manifold 44 is designed to close when pressure is applied to the system. When the pump is turned off and the pressure released, a drain manifold valve opens to allow excess water trapped in the hoses to drain, a feature normally used in the winter to prevent ice build-up in the lines.

Trailer

The pumping and filtration systems and water holding tank preferably are located in a seven by fourteen foot enclosed trailer 50 equipped with internal and external lighting. The trailer 50 is designed to be connected to an external power source, such as an electric utility or a portable generator. The trailer 50 can be towed by a standard half-ton pick-up using a bumper hitch. The pumps, filtration system and water holding tank remain inside the trailer 50 during use. The trailer 50 has outside connections for the intake hose 38 and discharge hoses 36. A winch system for tightening the cable 14 (FIG. 5) may be mounted to one or both exterior sides of the trailer 50.

Set Up

The water evaporation system 10 can be set up as follows. First, the trailer 50 is backed into position with the back of the trailer 50 located as close as possible to the deepest end of the pond 16. Tire chocks (not shown) should be used to prevent the trailer 50 from rolling backwards toward the pond 16 as pressure is applied to the cable winch system 26 as described below. Jacks (not shown) may be set under the trailer frame on the rear of the trailer, preferably on a flack cement block or similar structure, to prevent the trailer 50 from sinking into the ground.

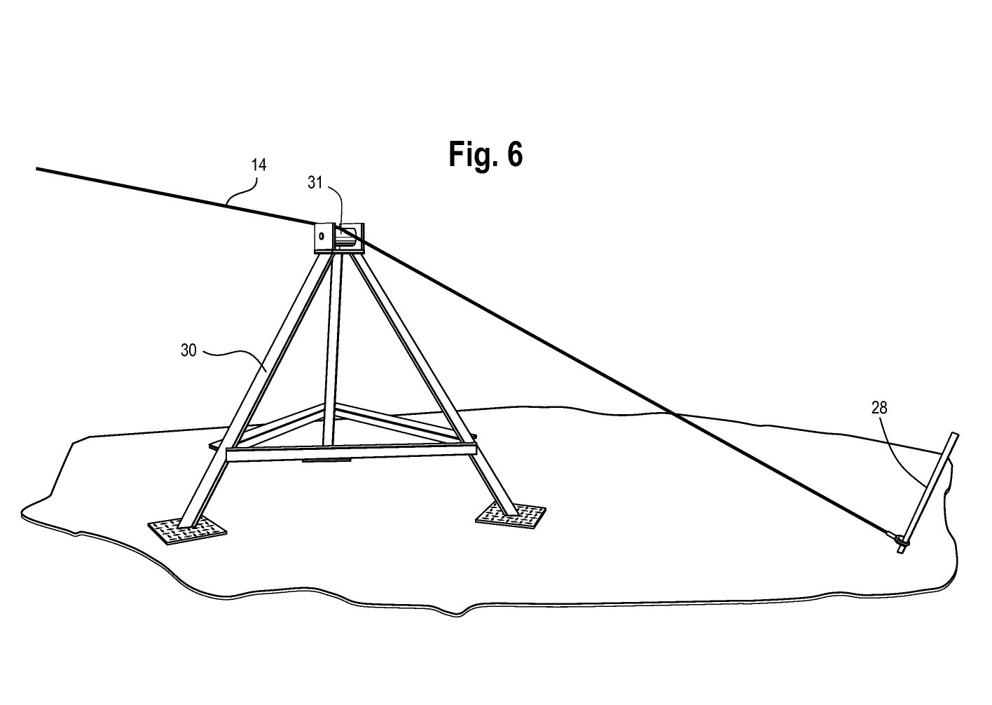

One tripod 30 (FIG. 6) for each cable 14 is placed on the other (distal) side of the pond 16, leaving sufficient space between the tripods 30 to ensure that the jump hoses 32 and connector hoses 34 between the nozzle arrays 12 do not dip into the water. The stakes 28 are then hammered into the ground at least about ten feet behind the tripods 30 on the side of the tripods 30 away from the pond 16. The stakes may be flagged for safety.

An operator then pulls the cable 14 across the pond, over a spool 31 mounted on top of the tripod 30, and hooks the cable 14 to a stake 28. The cable 14 may be flagged as a safety precaution for humans and wildlife. The cable 14 is then tightened using the trailer mounted winch 26.

The nozzle arrays 12 typically are transported to the site without the high pressure nozzles 20 attached, so before or after hanging the nozzle arrays 12 from the cable 14 a nozzle 20 should be connected to each male quick connect fittings 19. After a nozzle array 12 is hung from each cable 14, a ninety degree fitting 24 is connected to the distal ends of the two nozzle arrays 12 and two ten foot long high pressure hoses 34 are connected to the two ninety degree fittings 24 to close the water loop. A drain manifold 44 is connected between the two ten foot long high pressure hoses 34.

After assembling the nozzle arrays 12 and connecting their distal ends with the high pressure connector hoses 34 and drain manifold 44, the assembly is slid across the cables 14 and the other two nozzle arrays 12, if used, are hung from the cable 14. The two nozzle arrays 12 on each cable 14 are then connected by a short (about two foot long) jump hose 32.

One or more discharge hoses 36 are connected to the proximal ends of the nozzle arrays 12 and the nozzle arrays 12 are slid over the cable 14 to center the nozzle arrays 12 over the pond 16. The free ends of the discharge hoses 36 are connected to quick connect fittings 46 mounted in the back door of the trailer 50.

One end of the intake hose 38 is placed in the pond, preferably tied to a float to keep the intake end off the bottom of the pond, and the other, downstream end is connected to a quick connect 46 mounted near the rear of the trailer 50.

Operation

After the system 10 is set up as described above, the trailer 50 must be connected to a source of electricity, supplied either by an electric utility or a portable generator (not shown). The suction pump is then turned on and the system primed to make sure the pump and the hoses are full of water. Water then begins moving through the intake hose 38 to the filtration system and into the water holding tank located inside the trailer 50. Once the water holding tank is full, the high pressure pump is turned on to begin pumping water from the holding tank through a water manifold and through one or more discharge hoses 36 to the nozzle arrays 12. As the water is sprayed through the high pressure nozzles 20 it is atomized to form a fog.

### Improved Efficiencies

Previous water evaporation systems have achieved between 0.5% to 1% wintertime efficiencies, measured as the volume of water evaporated divided by the volume pumped through the system, and up to 4.5% summertime efficiencies. Early data indicate the new system 10 can achieve water evaporation efficiencies of up to 20% at outdoor temperatures of about 24-27 F and up to 40% at temperatures of about 41-47 F. These remarkable efficiencies primarily are due to the smaller water droplet sizes (about 60 microns) achieved by the system, substantially smaller than previous evaporation systems.

The embodiments of the invention described above are only particular examples which serve to illustrate the principles of the invention. Modifications and alternative embodiments of the invention are contemplated which do not depart from the scope of the invention as defined by the foregoing teachings and appended claims. It is intended that the claims cover all such modifications and alternative embodiments that fall within their scope.

We claim as our invention:

1. A water evaporation system for use in evaporating wastewater located in a pond or reservoir, the system comprising:
a pumping system for pumping the wastewater from the pond through one or more nozzle arrays;
one or more cables suspended over the pond;
means for suspending the one or more cables above the pond; and
one or more nozzle arrays connected to each cable, each of the one or more nozzle arrays comprising a conduit and a plurality of nozzles mounted to the conduit for converting the water into evaporable droplets.

2. The water evaporation system of claim 1 wherein the pumping system comprises:
a suction pump for pumping the wastewater from the pond through a filtration system and into a holding tank; and
a second pump for pumping the wastewater from the holding tank through the one or more nozzle arrays.

3. The water evaporation system of claim 2 wherein the second pump is a high pressure pump capable of pumping water at up to 3,000 PSI.

4. The water evaporation system of claim 1 wherein the suspending means comprises:
one or more vehicle mounted winches located near the pond, each cable being functionally attached to a winch so that the winch can be used to tighten the cable.

5. The water evaporation system of claim 4 wherein the suspending means further comprises a tripod located near the pond and distant the vehicle mounted winch such that the cable is suspended over the pond and between the winch and the tripod.

6. The water evaporation system of claim 1 wherein the nozzles are connected to the conduit by quick connect fittings.

7. The water evaporation system of claim 1 wherein the nozzles are arranged along the length of the conduit, the nozzles pointing upward at an angle of at least about 45 degrees with respect to the pond surface.

8. The water evaporation system of claim 1 wherein the number of cables is more than one.

9. The water evaporation system of claim 8 wherein the number of cables is two, one or more nozzle arrays are suspended from each cable, and the nozzle arrays farthest away from the pumping system are connected to each other by a pair of connector hoses and a drain manifold located between the connector hoses.

10. The water evaporation system of claim 9 wherein the number of nozzle arrays suspended from each cable is more than one and they are connected to each other with jump hoses.

11. The water evaporation system of claim 1 wherein the nozzle arrays are suspended from the cables by carabineers.

12. The water evaporation system of claim 2 wherein the pumping and filtration systems are located in an enclosed, portable trailer.

13. The water evaporation system of claim 12 further comprising:
an intake hose running from the pond to the suction pump; and
one or more discharge hoses downstream of the holding tank and running from the trailer to the nozzle arrays;
wherein the trailer has outside connections for the intake hose and the one or more discharge hoses.

14. The water evaporation system of claim 4 wherein the one or more winches are mounted to an exterior side of the trailer.

15. A method for evaporating water from a pond having a surface and a shoreline, the method comprising the steps of:
pumping the water from the pond through a filtration system into a holding tank;
pumping the water from the holding tank into one or more nozzle arrays suspended from a cable located above the surface of the pond, the nozzle arrays comprising nozzles mounted to conduit; and
spraying the water through the nozzles in a fine fog, thereby creating water droplets which evaporate.

16. The method of claim 15 wherein the spraying step creates water droplets having an average droplet diameter of about 60 microns.

17. The method of claim 15 wherein the water is pumped from the holding tank into one or more nozzle arrays at a rate of about 38 gallons per minutes and a pressure of up to 3,000 PSI.
